(19) United States
(12) Patent Application Publication
(10) Pub. No.: US 2011/0203871 A1
(43) Pub. Date: Aug. 25, 2011

(54) ELECTRONICALLY CONTROLLED FALL ARRESTER FOR A FALL PROTECTION SYSTEM

(76) Inventors: Nicolas Faye, Saint Viatre (FR); Thorsten Mahr, Oberkotzau (DE)

(21) Appl. No.: 13/055,774

(22) PCT Filed: Jul. 27, 2009
(86) PCT No.: PCT/EP09/59628

§ 371 Date: Apr. 1, 2011

(30) Foreign Application Priority Data
Jul. 25, 2008 (FR) 08/04249
Nov. 21, 2008 (DE) 202008015.472.3

(51) Int. Cl. A62B 35/00

(52) U.S. Cl. 182/3

(57) ABSTRACT

The fall arrester (10) for a fall protection system can be guided in a guide rail (12) and a protected person can be fastened to an anchor point of the fall arrester. The fall arrester (10) comprises a locking device (30) which can be shifted between a first, unlocked position an a second position locking the fall arrester on the guide rail. A holding device retains the locking device back in the first unlocked position. The locking device is preloaded into the second, locking position. The fall arrester (10) further comprises an electrical/electronic speed determining device (60) and an electronic control system (70) for releasing the holding device when a pre-determined speed is exceeded, and thereby releasing the locking device (30) for shifting to the second, locking position. The locking device (30) can comprise a two-part pawl latch (100) consisting of a lever (104) and a latching lug (102) designed as two separate elements rotatably mounted on an axle (120), wherein the anchor point of (18) is located at one end of the lever (104).

### TECHNICAL FIELD

The invention relates to a fall arrester for a fixed climbing protection system for preventing a person from falling off a ladder, a platform or the like. The fall arrester, which is also called a runner, is guided in a guide rail. The person to be secured wears a full body harness and is connected to the runner via a connection means. For this, the connection means is fastened to an anchor point of the runner. The fall arrester has a locking device which can be shifted between a first, unlocked position and a second position locking the fall arrester on the guide rail. A holding device holds the locking device back in the first, unlocked position, and the locking device is preloaded into the second, locking position. In the event of a fall, the locking device is triggered in speed-dependent manner.

### STATE OF THE ART

Mechanical fall arresters are known from DE-U-295 01 716 and WO 99/49939. The fall arresters are guided along the guide rail of the climbing protection system. The locking device has a swivellably housed catch, wherein one end of the catch has the anchor point and the other end a detent lug and wherein in the case of a fall the detent lug engages in catching stops of the guide rail and thus prevents a fall. The catch is preloaded into the locking position via a spring. The detent lug of the catch points downwards, with the result that during ascent the catching stops of the guide rail are travelled over. During descent, the user leans back slightly (leaning back), with the result that the catch is brought into the unlocked position and the runner can move downwards unhindered.

As a fall in a climbing protection system is different above all because of the increased speed of the entrained runner compared with the normal speed of travel within the climbing protection system, it is conceivable to design fall arresters with speed-dependent locking devices. Such a fall arrester is described in DE 103 42 627 A1. The fall arrester described there has a spring-loaded catch, on the non-catching end of which there is a feeler roller, and an anchor point. If the person to be secured moves slowly and in a controlled manner down the climbing protection system, the feeler roller is guided over catching stops of the guide rail, wherein a spring always pulls the catch back into its starting position in good time, with the result that the catch does not engage in the catching stops of the guide rail. In contrast, in the case of a fall, during which the fall arrester moves clearly faster along the guide rail, there is not enough time for the restoring spring to pull the catch back into the starting position, with the result that the catching end engages in the catching stops of the guide rail and thus prevents the fall. However, a disadvantage of this fall arrester is that the mechanical parameters that determine the catching speed, such as the spaces between the catching stops or the moment of inertia of the catch, can no longer be varied after completion. It is thus not possible to adapt the properties of the fall arrester to the conditions in question.

A fall arrester with a speed-dependent locking device is also known from EP 1 820 539, wherein the locking device has a centrifugal clutch. During movement of the fall arrester, a friction wheel rolls along the guide rail and its circumferential velocity is thus proportional to the speed of the fall arrester. When a defined speed threshold value is exceeded, a restraint device is released by the centrifugal clutch, with the result that a preloaded locking bar is pressed into a recess in the guide rail and the fall arrester is thus locked.

An emergency braking system for an elevator is known from DE 21 28 662, in which a generator ascertains an electrical value that corresponds to the speed of the elevator. When a threshold value is exceeded, the locking device is triggered via an electromagnet and the movement of the elevator is stopped. The locking device itself consists of two pairs of brake shoes, the toothed outer edges of which can engage with opposite guide rails of the elevator and bring the elevator to a stop via friction.

### DESCRIPTION OF THE INVENTION

### Technical Problem

The problem of the present invention is to provide a fall arrester, the locking device of which reacts to speed, wherein the speed at which the locking device engages can be adjusted.

### Technical Solution

According to the invention, this problem is solved in that the fall arrester has an, electronic apparatus for determining speed which triggers the locking device depending on the speed of the runner.

### Advantageous Effects

The locking device is triggered particularly quickly as a result of the electronic speed determination.

The locking device preferably has a holding device with an electromagnet, wherein the holding device is uncoupled or released by exciting the electromagnet.

The fall arrester preferably has an electronic control system which activates the locking device by uncoupling or releasing the holding device if the speed of the runner exceeds a predetermined threshold speed, e.g. in the event of a fall.

The locking device preferably has a mobile stopping element which is held, during operation, in a first, unlocked position by means of the holding device. If the holding device is uncoupled, the mobile stopping element is disconnected and pressed into the second, locking position by a stressing element, e.g. a spring.

The mobile stopping element is preferably a mobile bolt or a rotatably housed catch.

The locking device preferably represents a combination of electrical and mechanical protection means. For this, the locking device has a two-part catch. One part of the catch is formed by the detent lug rotatably housed on an axis. The other part is formed by a mechanical lever which is also rotatably housed, expediently on the same axis as the detent lug, and which has the anchor point. The lever and the detent lug are held together by means of the holding device, with the result that the combination of lever and detent lug functions like a conventional catch. If the holding device is uncoupled, the detent lug detaches itself from the mechanical lever and is pressed into the locking position. The two-part design of the catch also makes it possible to reduce the reaction time of the locking device.

Moreover, the two-part embodiment has a particularly positive effect should the electronic control system of the electromagnet malfunction (e.g. defective electromagnet). As a result of the advantageous combination of mechanical and electronic protection means, the fall arrester is then in fact not without effect, but can still provide adequate protection for the user with the help of the mechanical locking device. As a result of this embodiment, the proven safety of conventional fall arresters is supplemented in a particularly advantageous way by the option of individually setting the speed at which the locking device is triggered and adapting it to the special needs of the user as well as the conditions of the respective climbing protection system. The fall arrester thus increases the safety of the climbing protection system and, at the same time, offers a substantially greater ease of use than with conventional fall arresters.

In the two-part embodiment, by the first unlocked position is meant here the position in which the detent lug is held against the lever by the holding device. In the second, locking position, in contrast, the holding device has released the detent lug, with the result that the latter has detached itself from the lever. If the electronic system fails and therefore the mechanical lever swivels together with the detent lug, like a conventional, one-part catch, against the catching stops of the guide rail and locks on them, the detent lug is in the locking position, although the holding device has not released and still holds back the detent lug. However, electronic systems normally react more quickly than mechanical systems, with the result that, for the sake of simplicity, this linguistic inaccuracy can be accommodated.

For determining speed, the electronic apparatus preferably has a generator which is driven via a wheel or a roller, wherein the wheel is pressed against the guide rail of the climbing protection system, with the result that it is in constant contact with the running surface of the guide rail.

The electrical energy that is generated by the generator when the runner moves on the rail is preferably also used to supply electrical energy to the electronic control system and the electromagnet. In particular, the electrical energy generated by the generator can be stored in capacitors in order to provide the control system with enough energy to excite the electromagnet. The electrical energy provided by the generator can alone be enough to supply the control system and the electromagnet. The fall arrester is thereby completely self-sufficient and independent in relation to the energy supply.

The electronic apparatus for determining speed can also have other optical or electronic elements. In a preferred embodiment, the speed of the runner is determined via an optical sensor (e.g. speckle sensor) using the optical flow. The speed can also be determined via capacitive or inductive methods.

The speed threshold is preferably chosen such that it is above the speed that the runner reaches when the user is using the climbing device normally. The fact that the locking device of the runner is triggered depending on its speed makes the blocking of the runner independent of possible stresses on the anchor point by the user. In the case of a fall, the blocking of the runner is not prevented by the fact that the user pulls on the anchor point.

In the event of a fall, the locking device according to the invention can react earlier than according to the state of the art. In particular, the threshold value of the speed is chosen such that it corresponds to a drop height of less than or equal to 50 cm, preferably less than or equal to 10 cm. In practice, it is advantageous to choose this threshold value in a range between 0.7 and 1.5 m/s, better still 0.8 to 1.2 m/s.

The locking device is advantageously attached on the runner such that a manipulation of the mobile stopping element by the user is prevented when the runner is mounted on the rail. The user thus cannot prevent the stopping element from blocking the runner on the rail if the user falls.

With the same aim, it is further advantageous to attach the stopping element on the runner such that the user cannot mechanically work on the stopping element with a tool in order to block it, so as to prevent the movement into the second, locking position when the runner is mounted on the rail.

### BRIEF DESCRIPTION OF THE DRAWINGS

Embodiment examples of the invention are explained below with reference to the drawings. There are shown in:

FIG. 1 the fall arrester for personal fall protection according to a first embodiment of the invention in a schematic diagram;

FIG. 2 the fall arrester for personal fall protection according to a second embodiment of the invention in blocked position;

FIG. 3 the fall arrester for personal fall protection according to a second embodiment of the invention in released position;

FIG. 4 the fall arrester of FIG. 2 in a three-dimensional representation;

FIG. 5 the housing of the speed-determining apparatus of FIG. 4 in section;

FIG. 6 the fall arrester for personal fall protection according to a fourth embodiment of the invention, wherein the mechanical locking device is blocked and stops the free movement of the runner;

FIG. 7 the fall arrester from FIG. 6, wherein the locking device is in its first, unlocked position in which it allows a free movement of the runner along the guide rail;

FIG. 8 the fall arrester from FIG. 6, wherein the electronic locking device is blocked and stops the free movement of the runner;

FIG. 9 the fall arrester for personal fall protection according to a fifth embodiment mounted on a section of rail in a three-dimensional representation;

FIG. 10 the fall arrester from FIG. 9, wherein the locking device allows a free movement of the runner along the guide rail;

FIG. 11 the fall arrester from FIG. 9, wherein the electronic locking device is blocked and stops the free movement of the runner;

FIG. 12 the fall arrester of FIG. 9, wherein the mechanical locking device is blocked and stops the free movement of the runner; and

FIG. 13 the fall arrester from FIG. 9 in a three-dimensional representation without the rail.

### WAY(S) OF CARRYING OUT THE INVENTION

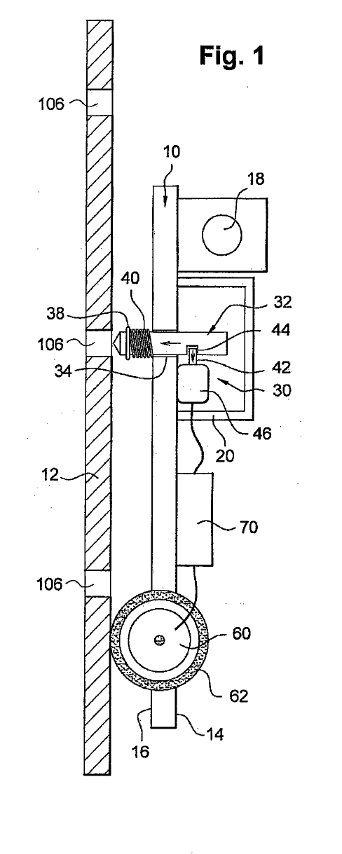

A schematic diagram of a fall arrester 10 according to the invention of a personal fall protection means is represented in FIG. 1. The schematic diagram is simplified in order to explain the principle of a locking device 30. The fall arrester or the runner 10 is guided along a rail 12. The runner 10 is mounted such that it slides on the rail 12. FIG. 1 does not represent the means of the runner 10 by which it can slide on the rail 12. In this regard, the rail 12 and the runner 10 can be designed according to the state of the art. The runner 10 has a housing 20 with a front 14 and a back 16. When the runner 10 is fitted on the rail 12, the back 16 faces the rail 12 and the front 14 the user. The runner 10 has an anchor point 18 as well as the locking device 30 which can prevent the runner 10 from sliding on rail 12 at least in a downward movement if the speed of the runner 10 exceeds a predetermined threshold value. The anchor point 18 is attached, in this schematic diagram, to the housing 20 of the runner 10, and thus does not engage in the locking device 30 described below independently of a stress exerted by the user.

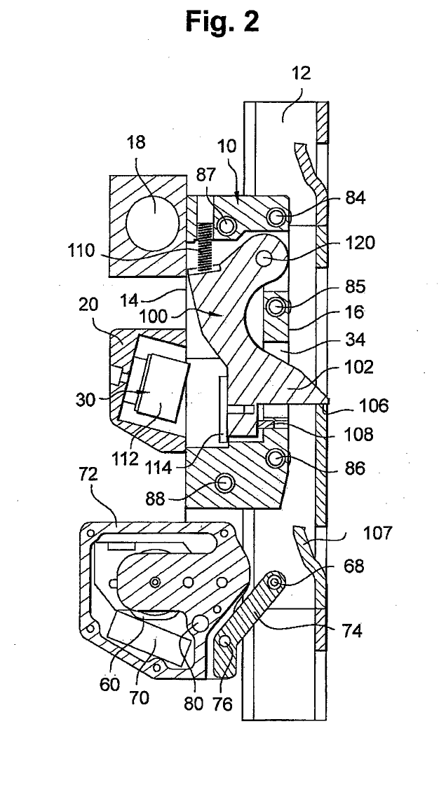

The locking device 30 comprises a bolt 32 which is mounted sliding in an opening 34 in the runner 10. The bolt 32 can be in two positions. In a first position, the bolt 32 is withdrawn as far as possible into the housing 20 of the runner 10 and makes possible the free movement of the runner 10 along the rail 12. At intervals, the rail 12 has catching stops 106 in the form of openings or catching stops 107 in the form of pawls (FIG. 2). In the second position, the bolt 32 protrudes so far beyond the back 16 of the runner 10 that it engages in one of the catching stops 106 of the rail 12 and thus blocks the movement of the runner 10 along the rail 12. A stop 38 is provided to limit the sliding of the bolt 32 in the direction of the rail 12. The bolt 32 is stressed in the direction of the second, blocking position by means of a compression spring 40. The housing 20 of the runner 10 is designed such that it covers the whole locking device 30, and thus the user has no access to the locking device 30 from the front 14 of the runner 10. The user is thereby prevented from engaging in the locking device 30 either intentionally or unintentionally. The fact that the bolt 32 protrudes from the back 16 of the runner 10 is not a disadvantage, as the back 16 is not accessible for the user when the runner 10 is sitting on the rail 12.

The locking device 30 furthermore has a holding device by which the bolt 32 is held in the first, non-blocking position. The holding device consists of a pin 42 which engages in a recess 44 of the bolt 32. The pin 42 can be designed as a magnetic core of an electromagnet 46 and be preloaded by a spring, not represented in FIG. 1, into the recess 44 of the bolt 32. In this situation, the electromagnet 46 is switched off. The holding device is uncoupled by exciting the electromagnet 46, whereby the pin 42 is drawn into the electromagnet 46 and, at the same time, pulled out of the recess 44 of the bolt 32. The preloaded bolt 32 is then moved by the spring 40 into the second, blocking position, and stops the free movement of the runner 10 along the rail 12.

The locking device 30 is triggered if the sliding speed of the runner 10 in the rail 12 exceeds a predetermined speed that is representative of a fall situation. The speed of the runner 10 is determined with the help of an electric generator 60 which is mounted on the runner 10. The electric generator 60 has a rotor axis which is driven by a friction wheel 62 or a roller that rolls along the rail 12. The friction wheel 62 can be fastened directly on the axis of the rotor of the generator 60 or transmit the rotation to the latter via a movement transmission system. The voltage, or frequency of the electrical signal generated by the generator 60 typically increases with the rotational speed of the rotor. An electronic control system 70 is connected to the generator 60 and picks up its voltage or frequency signal. It excites the electromagnet 46 and thus triggers the locking device 30 as soon as the value generated by the generator 60, characteristic of the speed of the runner 10, exceeds a previously defined threshold value. The speed threshold value can be fixed or adjustable for example via a potentiometer.

The electronic control system 70 can be an electronic card or printed circuit which a person skilled in the art readily knows how to use. If for example the value characteristic of the speed is the electrical voltage delivered by the generator 60, the comparison can be drawn by means of an electronic circuit.

The electrical energy that is generated by the generator 60 when the runner 10 moves on the rail 12 can be used to supply electrical energy to the electronic control system 70 and the electromagnet 46. In particular, the electrical energy generated by the generator 60 can be stored in capacitors in order to guarantee the control system 70 enough energy to excite the electromagnet 46. The electrical energy provided by the generator 60 can alone be enough to supply the control system 70 and the electromagnet 46. The fall arrester 10 is thereby completely self-sufficient and independent in relation to the energy supply.

If the runner 10 is blocked on the rail 12 after the bolt 32 has passed into the second, blocking position, the user can then reset the bolt 32 in the non-blocking position by hand, for example by pressing on the end of the bolt 32 from the rearward part of the rail 12 until the pin 42 again engages in recess 44 of the bolt 32.

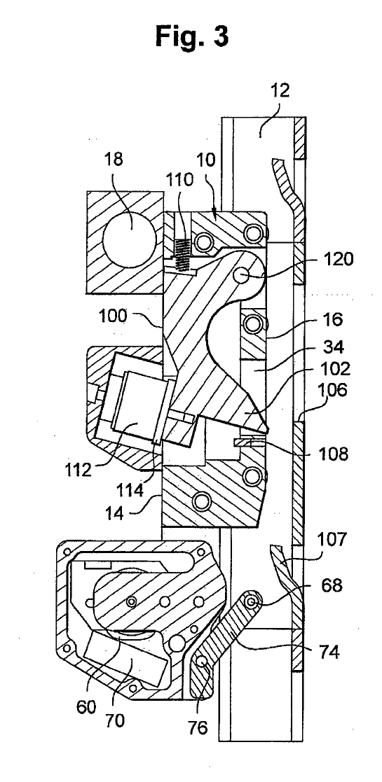

The second embodiment represented in FIGS. 2 and 3 of the fall arrester 10 is also guided on the guide rail 12. The guide rail 12 is a C-profile, wherein the opening edges of the C-profile act as guide flange. The runner 10 has, on both sides, guide grooves 82 that receive the guide flange of the guide rail 12. Guide rollers 84 to 89 which roll along the outside and inside of the guide flange protrude in the guide grooves 82. The guide rollers 84 to 89 are preferably made of plastic or elastomer or covered with such a material, in order to limit the generation of noise when the runner 10 slides on the rail 12. The rollers 84 to 89 also ensure the positioning of the runner 10 in relation to the rail 12 and consequently of the friction wheel 62 on the rail 12.

Unlike in the first embodiment, here the central element of the locking device 30 is a catch 100, rotatably housed in the runner 10, which can be swivelled into a first and a second position. In the first position, represented in FIG. 3, a detent lug 102 of the catch 100 does not engage in the rail 12 and therefore allows a free upward and downward movement of the runner 10 along the rail 12. In the second position, represented in FIG. 2, the detent lug 102 of the catch 100 engages in the catching stops 106, 107 of the rail 12 and thus blocks the downward movement of the runner 10. An upward movement of the runner 10 is also possible in the second position, as the detent lug 102 of the catch 100, as a result of its bevelled shape, can be moved over the catching stops 106, 107 of the guide rail 12 during the upward movement. A stop 108 on the runner 10 prevents the catch 100 from moving beyond the second position. The stop 108 can be designed fixed and in one piece with the runner 10. It can also be adjustable, in order that the extent of the projection of the detent lug 102 of the catch 100 beyond the back wall 16 of the runner 10 is adjustable. The runner 10 can thereby be adapted to different rails 12 with larger or smaller spaces between the catching stops 106, 107 from the back 16 of the runner 10. The stop 108 is for example a headless screw screwed into the runner 10.

The catch 100 is stressed in the direction of the second position. The stressing means is preferably an elastic stressing element, for example a spring 110, between the runner 10 and the catch 100. As an alternative, the stressing on the catch 100 in the direction of the bottom of the rail 12 can be achieved only as a result of the gravity which acts on the catch 100.

As in the first embodiment, the fall arrester 10 has a holding device which holds the catch 100 in the first position during normal operation and can be uncoupled in order to make possible the movement of the catch 100 into the second position. The holding device can be identical to that of the first embodiment, except that the recess 44 is provided in the catch 100.

An advantageous variant of the holding device is represented in FIGS. 2 and 3. It comprises a magnetic base or permanent magnet 114 and an electromagnet 112 with a metal or other surface which is suitable for the permanent magnet 114 to adhere to it permanently when the electromagnet 112 is not switched on. The permanent magnet 114 is preferably fastened to the catch 100 and the electromagnet 112 to the runner 10. The electromagnet 112 holds the catch 100 in the first position as a result of the permanent magnet 114 magnetically adhering to the corresponding surface of the electromagnet 112. The holding device is uncoupled by switching the electromagnet 112 on in order to produce a magnetic force which counteracts the magnetic adhesion of the permanent magnet 114 and it is sufficient to release the permanent magnet 114 from the corresponding surface of the electromagnet 112. The preloaded catch 100 is pivoted by the spring 110 into the second position, with the result that the detent lug 102 of the catch 100 engages in one of the catching stops 106, 107 of the guide rail 12 and thus stops the downwardly directed movement of the runner 10 on the rail 12. The swivelling of the catch 100 into the second position results from the stress applied by the spring 110 or any other above-mentioned stressing means, but the pivoting speed can advantageously be increased by magnetically repelling the permanent magnet 114 away from the electromagnet 112, in order to ensure a faster blocking of the runner 10 in rail 12.

As in the first embodiment, the locking device 30 is activated according to this second embodiment when the sliding speed of the runner 10 on the rail 12 exceeds a predetermined threshold speed which is representative of a fall situation.

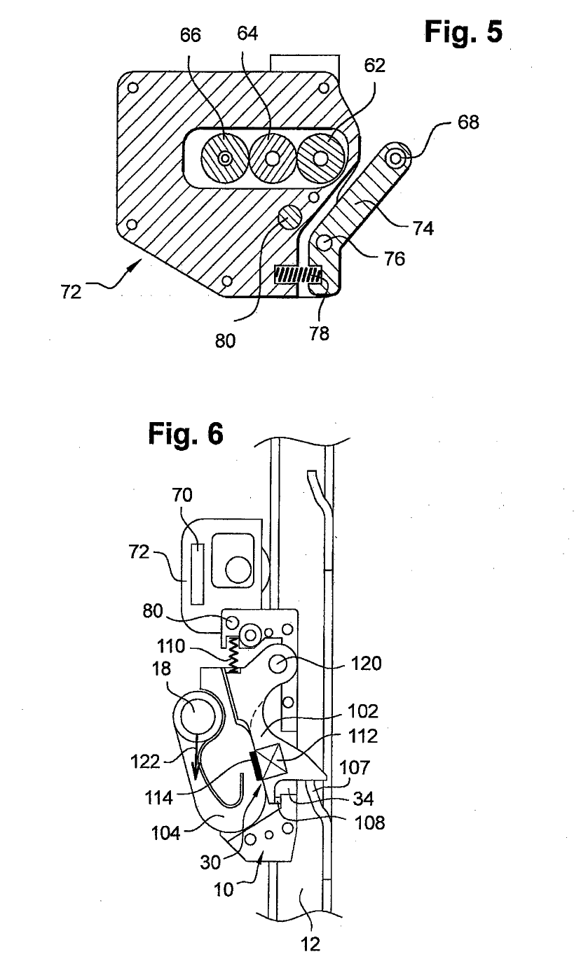

In the example represented, the electronic control system 70 and the electric generator 60 are accommodated in the same housing 72. As FIG. 5 shows, the housing 72 also contains the friction wheel 62 which is to roll along the front of the rail 12, as well as two further wheels or rollers 64 and 66. The friction wheel 62 drives the rotor of the electric generator 60 by rotation, wherein the friction wheel 62 drives the roller 64 which in turn drives the roller 66 on the rotor axis of the electric generator 60.

Moreover, a counter roller 68 is provided in order to ensure the contact between the friction wheel 62 and the rail 12. The counter roller 68 is to roll along the front wall of the rail 12 opposite the friction wheel 62. It is preferably to be provided that the front wall of the rail 12 is clamped elastically between the friction wheel 62 and the counter roller 68. For this, the counter roller 68 can be elastically stressed against the friction wheel 62. Moreover, the counter roller 68 can be attached rotating on the end of an arm 74 which is attached pivoting in relation to an axis 76 on the housing 72. The end of the arm 74 which carries the counter roller 68 is stressed in the direction of the friction wheel 62 by a compression spring 78 which is only represented in FIG. 5. Finally, it is advantageous to provide a device in order to absorb the play in order to ensure, e.g. should the front of the rail 12 display changes in shape, that there is contact between the friction wheel 62 and the rail 12. In the example represented, this is achieved by mounting the housing 72 pivoting about an axis 80 on the runner 10 together with the counter roller 68.

Of course, the guide means and the arrangement of the housing 72 with the above-described components can also be used within the framework of the first embodiment.

The catch 100 is arranged on the runner such that manual engagement by the user is avoided. In a still more advantageous arrangement, the catch 100 can be arranged such that the user can be prevented from blocking the catch 100 by using a tool, for example a screwdriver, between catch 100 and runner 10, in order to prevent a movement towards the rail 12. In the example represented, the electromagnet 112 is accommodated in a housing 20 fastened on runner 10. More precisely, this housing 20 is fastened on the front 14 of the runner 10 above the opening 34 in which the catch 100 lies. In the mentioned example, the housing 20 covers only part of the opening 34, namely the lower part with the detent lug 102 of the catch 100 which lies opposite its pivot axis 120. The housing 20 thus prevents the user from being able to intentionally stop the catch 100 from engaging in the catching stops 106, 107 on the bottom of the rail 12 by manually engaging in the free part of the catch 100 or by inserting a tool, for example a screwdriver, into the opening 34 between the free end of the catch 100 and the runner 10. In the part of the opening 34 not covered by the housing 20, the user cannot grip or block the catch 100, as this does not protrude beyond the front 14 and the play between the side walls of the catch 100 and the side walls of the opening 34 is small enough to prevent the user from inserting a finger or a tool, for example a screwdriver. In a variant, the opening 34 is completely closed at the front 14 by the housing 20 or any other suitable means, for example a plate attached to runner 10 above the part of the opening 34 not covered by housing 20. The fact that the catch 100 can project in relation to the back 16 of the runner 10 is not a disadvantage from a safety point of view, as the back 16 of the runner 10 is not accessible for the user when the runner 10 is mounted on the rail 12, as the walls of the rail 12 enclose the rearward part of the runner 10.

If the locking device 30 has been triggered and the free movement of the runner 10 in the rail 12 is blocked, it is provided that the user can bring the catch 100 into the first position again in order to continue climbing down or up the climbing device. In the example represented, the pawls or catching stops 107 of the rail 12 cause during an upward movement of the runner 10 a sufficient pivoting movement of the catch 100 in the direction of the first position, with the result that the permanent magnet 114 again magnetically adheres to the corresponding surface of the electromagnet 112 because the electromagnet 112 is no longer excited. As soon as the catch 100 is in the first position, the fall arrester 10 is ready for use again for personal fall protection.

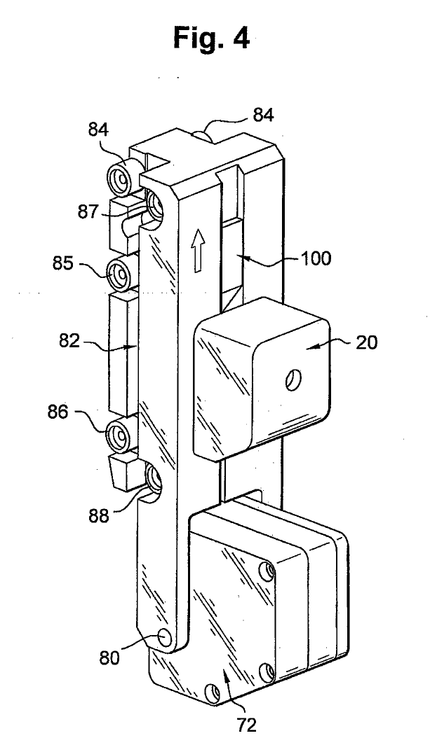

FIG. 4 shows a three-dimensional representation of the fall arrester 10 according to this second embodiment. For reasons of clarity, the anchor point 18 is not represented.

In a third, not represented embodiment, the fall arrester 10 has a second, mechanical locking device in order to block the sliding of the runner 10 in the rail 12 if the user falls, wherein this second locking device corresponds to the state of the art, as described for example in DE-U-295 01 716. The second locking device comprises a further catch which can be swivelled from a first position, in which it does not prevent the downward movement of the runner 10 on the rail 12, into a second position, in which it blocks the downward movement of the runner 10 on the rail 12. In this case, the anchor point 18 is attached on this second catch. The passage of the second catch from the first position into the second is triggered by the change to downward direction as the result of a pull exerted on the second catch by the user via a connection means with which he is fastened to the anchor point 18. The second locking device operates independently of the first locking device 30 according to the first or second embodiment. If, consequently, one locking device is defective, the second continues to function. In particular, the second, conventional locking device further represents a fall protection means should the first locking device not function for example because of a failure of the electric generator 60 or the control system 70. In this embodiment, the first locking device 30 according to the first or second embodiment and the second locking device according to the state of the art can be attached in succession in longitudinal direction on the same runner 10.

FIGS. 6, 7 and 8 represent a fall arrester 10 for personal fall protection according to a fourth embodiment which is a further development of the second embodiment. The overall description of the second embodiment is therefore valid for this fourth embodiment with the exception of the constituents which are individually listed below. For reasons of clarity, the counter roller 68 has not been represented.

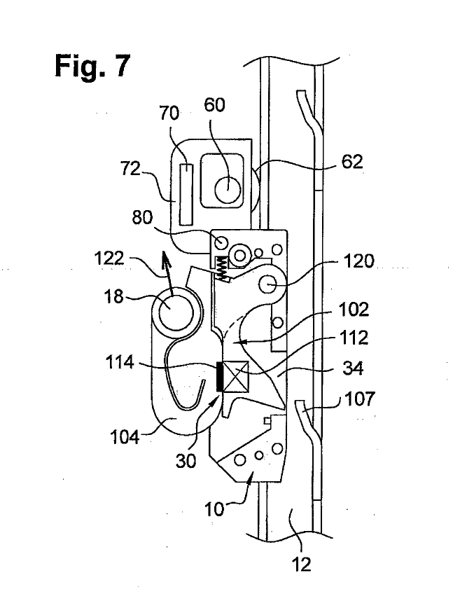

The fall arrester 10 has a catch which, unlike the catch 100 of the second embodiment, is designed in two parts. This two-part catch is composed of a mechanical lever 104 and a detent lug 102 which are rotatably housed independently of each other on the same axis 120. The mechanical lever 104 has the anchor point 18 to which the user is fastened via a connection means. The holding device of the locking device 30 serves to hold the detent lug 102 against the mechanical lever 104. For this, the holding device can have an electromagnet 112 which is released by current supply, as in the second embodiment. The electromagnet 112 is located on the detent lug 102, while the permanent magnet 114 is fastened opposite on the lever 104, or vice versa. If the holding device is coupled on, the permanent magnet 114 adheres to the corresponding surface of the electromagnet 112. During normal operation, the mechanical lever 104 and the detent lug 102 are therefore in fixed connection. The unit consisting of the mechanical lever 104 and the detent lug 102 thus functions similarly to a conventional catch according to the state of the art. The fact that the user pulls on the anchor point 18 backwards or upwards causes the two-part catch 102, 104 to be released from the catching stops 106, 107 on the bottom of the rail 12. This situation is represented in FIG. 7, in which the arrow 122 indicates the direction in which the tensile stress is exerted on the anchor point 18 by the connection means between the anchor point 18 and the user of the climbing protection system. This tension goes in the opposite direction to the stress exerted on the detent lug 102 by the spring 110.

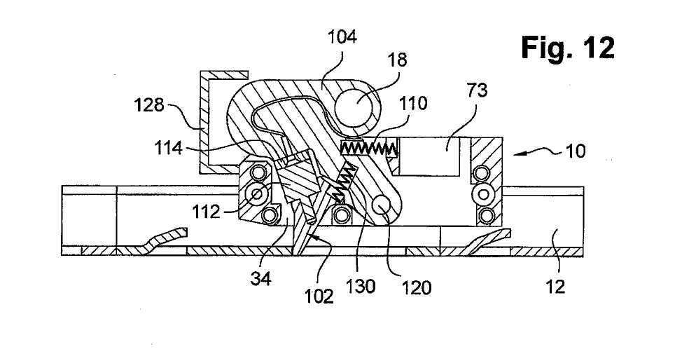

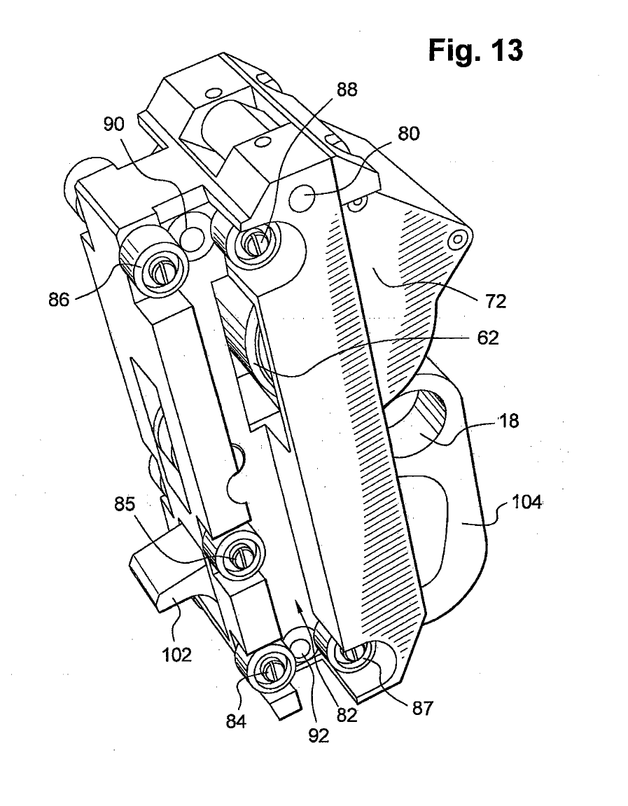

On the other hand, the consequence of the fact that the user pulls downwards on the anchor point 18, as is indicated by the arrow 122 in FIG. 6, is that the two-part catch 102, 104 is pressed in the direction of the rail 12. The detent lug 102 therefore engages in the catching stops 106, 107 on the bottom of the rail 12, as is represented in FIG. 6. The detent lug 102 consequently blocks the downward movement of the runner 10 on the rail 12. As a result of the bevelled shape of the catch 102, the upwardly directed travel of the runner 10 on the rail 12 remains possible. It is to be preferred that the lever 104 has a bearing surface 124 which is in contact with a surface 126 of the detent lug 102 in order to transmit shearing stresses of the mechanical lever 104 onto the detent lug 102 and in order to prevent this from occurring via the permanent magnet 114 and the corresponding surface of the electromagnet 112. For the rest, the detent lug 102 is attached on the runner 10 in such a way that a manipulation by the user is prevented. In the example represented, the part of the mechanical lever 104 in the direction of the upper end of the rail 12 forms a fork at the level of the axis 120. The part of the detent lug 102 in the direction of the upper part of the rail 12 is attached between the arms of the mechanical lever 104 which form the aforementioned fork. The detent lug 102 does not protrude beyond the front surface of the mechanical lever 104. Moreover, the play between the arms of the fork of the lever 104 and the upper part of the detent lug 102 is small enough to prevent the user from inserting a finger or a tool, for example a screwdriver, there. The user therefore cannot grip this part of the detent lug 102 or block it with the help of a tool. The whole of the remaining part of the detent lug 102 extends below the lever 104. Therefore the user cannot reach these areas of the detent lug 102 with his fingers either. The chosen play between the end of the lever 104 and the lower end of the rail 12 and the runner 10 can be small enough that the user cannot insert his finger there in order to hold the detent lug 102 back. A cover 128, not represented in FIGS. 6 to 8, can be provided which limits the access to the detent lug 102 still further. A possible embodiment of the cover 128 is represented in FIG. 12.

The housing 72 is attached to the front 14 of the runner 10. A friction wheel 62 is provided for rolling along the front of the rail 12. The friction wheel 62 is housed in the housing 72 and partially protrudes from this in order to come into contact with the rail 12. The friction wheel 62 is preferably mounted directly on the axis of the electric generator 60 in the housing 72. In the example represented, the housing 72 is mounted pivoting in relation to an axis 80 on the runner 10. As a result of this pivoting mounting, the play can be absorbed in order to ensure a permanent contact between the friction wheel 62 and the front wall of the rail 12 when the runner 10 slides on the rail 12. The housing 72 is preferably elastically stressed, for example via a spring, about the pivot axis 80 in the direction of rail 12 in order to ensure a permanent contact with the rail 12, even if the latter should display any changes in shape.

As described with reference to the second embodiment of the fall arrester, the electronic control system 70 triggers the locking device 30 if the sliding speed of the runner 10 on the rail 12 exceeds a threshold value above which it can be assumed that the user finds himself in a fall situation. The electronic control system 70 and the measurement of the sliding speed of the runner 10 on the rail 12 by means of an electric generator 60 can be designed in identical manner, as described with reference to the second embodiment. In FIGS. 6 to 8, however, the housing 72 which contains these components is attached to the upper end of the runner 10, which makes it easier to connect the electronic control system 70 to the electromagnet 112. Alternatively, it can be attached to the lower end, as is represented for the second embodiment.

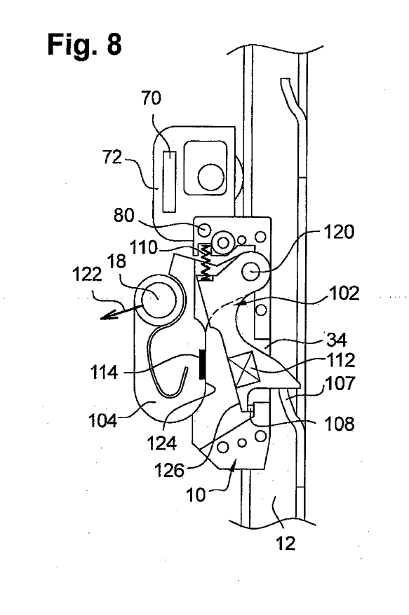

The effect of the uncoupling of the holding device is that the detent lug 102 is detached from the mechanical lever 104, as represented in FIG. 8. The detent lug 102 is stressed in the direction of the bottom of the rail 12 by the spring 110 and engages in the catching stops 106, 107 on the bottom of the rail 12 in order to block the downwardly directed movement of the runner 10 on the rail 12. The upwardly directed travel of the runner 10 on the rail 12 continues to be possible in this situation.

The fall arrester 10 according to this fourth embodiment is used as follows. In normal use, the detent lug 102 is in fixed connection with the lever 104 via the holding device. When the user uses the fall arrester 10 in a climbing system, he exerts a backwardly or upwardly directed tensile stress on the anchor point 18, with the result that the two-part catch is kept away from the area of the catching stops 106, 107 on the bottom of the rail 12. This tension can be manual or caused by a connection means between the user and the anchor point 18. This case is illustrated in FIG. 7. If the user falls, in the case of locking devices 30 with a conventional catch 100 a certain time passes until the catch 100 engages in the catching stops 106, 107 on the bottom of the rail 12 due to the downwardly directed tensile stress on the anchor point 18. The more time elapses until the locking device 30 is triggered, the further the user falls in the event of a fall. The reaction time of the locking device 30 is reduced by the two-part catch represented in FIGS. 6 to 8. As soon as the speed of the runner 10 on the rail 12 exceeds a previously defined speed, the electronic control system 70 uncouples the holding system, before the two-part catch is pressed into the catching stops 106, 107 of the rail 12 in a conventional way, thus under the influence of the downwardly directed tension on the anchor point 18. When the holding device is uncoupled, the detent lug 102 is detached from the lever 104 and stressed in the direction of the catching stops 106, 107 of the rail 12 under the influence of the spring 110. Consequently, the runner 10 on the rail 12 is blocked more quickly than with conventional fall arresters. In order to achieve this effect, the speed threshold value which is predetermined for the electronic control system 70 must, as explained above, be selected in suitable manner. FIG. 8 illustrates the situation represented in which the fall arrester 10 stops the user from falling, wherein the pull on the anchor point is still directed backwards, while the detent lug 102, which is no longer connected to the lever 104, is already engaging in the catching stops 106, 107 on the bottom of the rail 12. In the same way, the fall arrester 10 remains effective even when the user intentionally pulls the anchor point 18 backwards or upwards in order to prevent the catch 102 from engaging in the catching stops 106, 107 of the rail 12. As soon as the speed of the runner 10 exceeds the speed predetermined for the electronic control system 70, the holding device is released and the detent lug 102 is pressed into the catching stops 106, 107 of the rail 12, in order to block the movement of the runner 10 on the rail 12 despite the pulling movement by the user on the anchor point 18.

In this embodiment, the holding device is automatically recoupled when the mechanical lever 104 is likewise swivelled into the second position by the weight of the user in the event of a fail, a short time after the holding device is triggered, and is thereby brought back into contact with the detent lug 102. The permanent magnet 114 then again magnetically adheres to the corresponding surface of the electromagnet 112 because the electromagnet 112 is already currentless again at the time. Since the runner 10 is again stopped at this time and its speed thus lies below the comparison threshold, the electromagnet 112 has been de-energized again by the electronic control system 70.

Should a malfunction prevent the uncoupling of the holding device during the fall, if for example the generator 60 or the control system 70 were defective, the detent lug 102 would nevertheless be forced to press into the catching stops 106, 107 on the bottom of the rail 12 by the downward pull exerted by the weight of the user on the anchor point 18 and thus on the lever 104. The locking device 30 thus blocks the runner 10 in this case also on the rail 12, in a way such as is known in the state of the art.

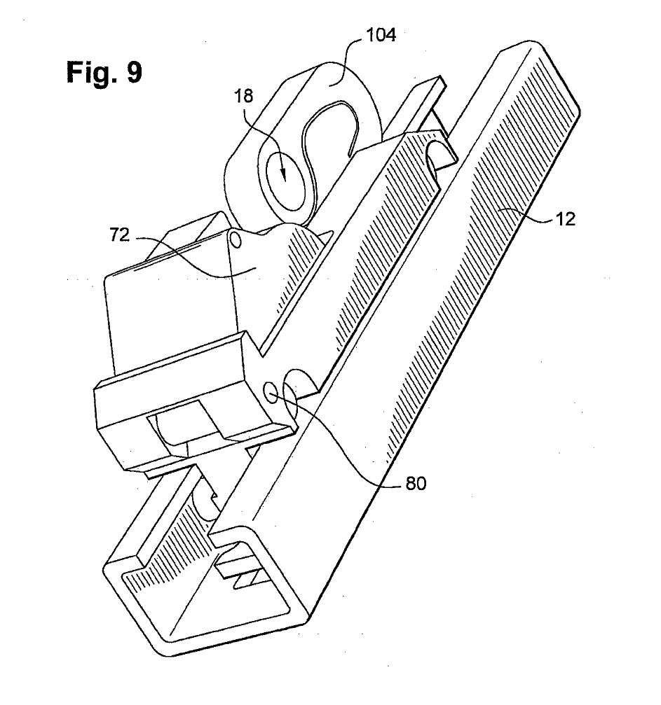

FIGS. 9 to 12 show the fall arrester 10 in a fifth embodiment which represents a further development of the fourth embodiment. The overall description of the fourth embodiment is therefore valid for this fifth embodiment with the exception of the constituents which are individually listed below.

Buffers 90 and 92 are fastened to the bottom of the lateral grooves 82. These buffers absorb impacts and mechanical oscillations between the bottom of the lateral grooves of the rail 12 and the runner 10 during movements on the rail 12 and limit the noise caused during the movement of the runner 10. The buffers 90, 92 can also be used in the above embodiments.

The catch is again designed in two parts, wherein in this case the detent lug 102 is rotatably housed with two fork-shaped arms on the axis 120. The lever 104 is mounted between the arms of the fork of the detent lug 102. As an alternative, the reverse configuration, as described in the fourth embodiment, can also be used.

Initially the spring 110 does not stress the detent lug 102 directly towards the rail 12, but only the lever 104, which then transmits the stress onto the detent lug 102. It is the task of another spring 130 to press the detent lug 102 against the catching stops 106, 107 of the rail 12 when the lever 104 is kept at a distance from the rail 12 and the detent lug 102 is detached from the lever 104. This case is represented in FIG. 11.

The advantage of two springs 110 and 130 is that the reaction speed of the locking device 30 is accelerated in certain cases. If, in the event of a fall of the user, the movements of the detent lug 102 and of the mechanical lever 104 are superimposed, the detent lug 102 is directly stressed by the spring 130 and at the same time indirectly stressed by the spring 110. Thus, the time required to swivel the detent lug 102 from the first into the second position, thus the reaction time of the locking device 30, is reduced.

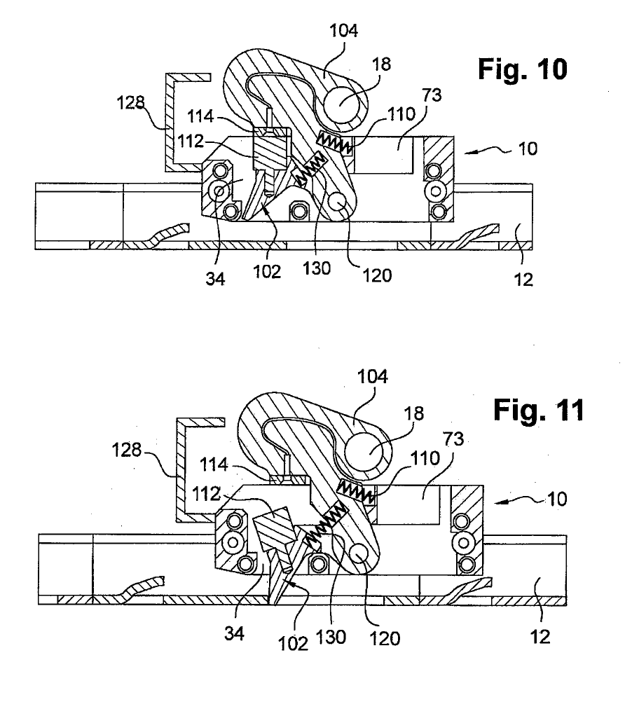

The measures that are taken to prevent the user from working on the detent lug 102 or blocking it with a tool are similar to those described with reference to the fourth embodiment. The cover 128 is also to be provided in order to prevent any insertion of a tool or a finger of the user, should the play between the part of the detent lug 102 which faces the lower part of the rail 12 and the opposite edge of the opening 34 of the runner 10 be large enough. The cover is shown schematically only in FIGS. 10 to 12.

As in the fourth embodiment, the housing 72 (not represented) including generator 60 and friction wheel 62 can be attached to the front 14 of the runner 10 in a recess 73.

The mode of operation of the protection device according to the fifth embodiment is identical to the mode of operation of the fourth embodiment with the exception of the aforementioned roller of the springs 110 and 130.

Of course, this invention is not limited to the described and represented embodiments, but can have many variants which are available to a person skilled in the art.

In the various embodiments described, the electronic control system 70 can be provided to establish, in addition to the speed, also the movement direction of the runner 10 on the rail 12 in order not to cause an uncoupling of the holding system if the speed threshold is exceeded during ascent. Blocking of the runner 10 on the rail 12 when the runner 10 travels upwards, i.e. in a direction that does not correspond to a fall, is thereby prevented. However, it is easier not to establish this and to always trigger the locking device 30 as soon as the speed threshold is exceeded, completely regardless of the direction in which the runner 10 is sliding. This speed threshold is normally not reached when the user is climbing up a climbing system and in this case the runner 10 is thus not blocked on the rail 12. Because it is bevelled, the detent lug 102 can normally travel over the catching stops 106, 107 in any event.

In the various embodiments, the speed is measured with the help of an electric generator 60. Alternatively, other means of measuring speed can be used. In particular, it is possible to use an inductive, capacitive or optical speed sensor which can cooperate with the catching stops 106, 107 on the bottom of the rail 12 or other elements which are incorporated into the rail 12 for this purpose. However, the use of an electric generator 60 is advantageous because it can also be used to generate just the electrical energy necessary for the operation of the fall arrester 10. In the various described embodiments, the electronic control system 70 is provided to activate the locking device 30 when the speed threshold is exceeded by the runner 10. Of course, the control system 70 can also be used to already activate the locking device 30 when the speed limit is reached.

### LIST OF REFERENCE NUMBERS

10 Fall arrester/runner
12 Guide rail
14 Front of the runner
16 Back of the runner
18 Anchor point
20 Housing
30 Locking device
32 Bolt
34 Opening
38 Stop
40 Spring
42 Pin
44 Recess
46 Electromagnet
60 Generator
62 Friction wheel
64 Roller
66 Roller
68 Counter roller
70 Control system
72 Housing
73 Recess
74 Arm
76 Axis
78 Compression spring
80 Pivot axis
82 Guide grooves
84 Guide roller
85 Guide roller
86 Guide roller
87 Guide roller
88 Guide roller
89 Guide roller
90 Buffer
92 Buffer
100 Catch
102 Detent lug
104 Mechanical lever
106 Catching stops
107 Catching stops
108 Stop
110 Spring
112 Electromagnet
114 Permanent magnet
120 Pivot axis
122 Direction of the tensile stress
124 Bearing surface
126 Surface
128 Cover
130 Spring

1-12. (canceled)

13. A fall arrester for a climbing protection system, which is adapted be guided in a guide rail having catching stops, comprising
an anchor point for securing a person;
a locking device which is adapted to be shifted between a first, unlocked position and a second position locking the fall arrester in the catching stops of the guide rail, the locking device being preloaded into the second position;
a holding device for holding the locking device back in the first, unlocked position;
an electrical speed-determining device; and
an electronic control system for releasing the holding device when a predetermined speed is exceeded and thereby releasing the locking device for shifting into the second position.

14. The fall arrester according to claim 13, wherein the locking device comprises one of a movable bolt and a rotatably housed catch.

15. The fall arrester according to claim 13, wherein the holding device includes an electromagnet and the holding device is designed such that it is released when the electromagnet is excited.

16. The fall arrester according to claim 15, wherein the electronic control system excites the electromagnet when the fall arrester exceeds a predetermined speed.

17. The fall arrester according to claim 13, wherein the locking device is a catch housed rotatably about an axis and is two-part including a lever and a detent lug which are designed as two separate elements and are rotatably housed on the axis, and wherein the anchor point is situated at one end of the lever.

18. The fall arrester according to claim 17, wherein, if the electronic control system malfunctions, in the event of a fall, the detent lug is adapted to be pressed into the catching stops of the guide rail by the lever.

19. The fall arrester according to claim 13, wherein the electronic speed-determining device has a generator which is driven by a friction wheel which rolls along the guide rail, and wherein the electrical signal generated by the generator is a measure of the speed of the fall arrester.

20. The fall arrester according to claim 19, wherein the generator delivers the energy required for the operation of the locking device and the electronic control system.

21. The fall arrester according to claim 20, which has a device which ensures the contact between the friction wheel and the rail.

22. The fall arrester according to claim 21, wherein the device has a counter roller which is adapted to press the friction wheel against the guide rail, with the result that the rail is clamped between counter roller and friction wheel.

23. The fall arrester according to claim 13, wherein the electronic speed-determining device contains one of optical, capacitive and inductive elements.

24. The fall arrester according to claim 13, in which the locking device is attached on the fall arrester such that a manual engagement in the locking device is prevented when the fall arrester is mounted on the guide rail.
